(19) United States
(12) Patent Application Publication
(10) Pub. No.: US 2016/0312542 A1
(43) Pub. Date: Oct. 27, 2016

(54) POLYCRYSTALLINE SUPER HARD CONSTRUCTION & METHOD OF MAKING

(71) Applicants: ELEMENT SIX LIMITED, County Clare (IE); BAKER HUGHES INCORPORATED, Houston, TX (US)

(72) Inventors: ROGER WILLIAM NIGEL NILEN, DIDCOT (GB); NEDRET CAN, DIDCOT (GB); HUMPHREY SITHEBE, SPRINGS (ZA); DAVID BOWES, DIDCOT (GB); DEREK NELMS, HOUSTON, TX (US)

(73) Assignees: ELEMENT SIX LIMITED, COUNT CLARE (IE); BAKER HUGHES INCORPORATED, HOUSTON, TX (US)

(21) Appl. No.: 15/105,163

(22) PCT Filed: Dec. 17, 2014
(86) PCT No.: PCT/EP2014/078203

§ 371 Date: Jun. 16, 2016

Related U.S. Application Data
(60) Provisional application No. 61/917,189, filed on Dec. 17, 2013.

(51) Int. Cl. E21B 10/573; C04B 37/00; B24D 18/00; C01B 31/06

(52) U.S. Cl. CPC E21B 10/5735; C01B 31/065; C04B 37/001; B24D 18/0009; C04B 2237/363; C04B 2237/36

(57) ABSTRACT

A polycrystalline superhard construction comprises a body of polycrystalline superhard material having two or more layers. A first layer differs from a second layer in one or more characteristics. The body has a thickness of greater than around 1.8 mm. A substrate is bonded to at least one of said layers, and one of the interface surface of the substrate or the body comprises one or more projections arranged to project from the interface surface, the height of the projection(s) being between around 0.2 mm to around 2.0 mm measured from the lowest point on the interface surface from which the one or more projections extend. At least a portion of the body of superhard material is substantially free of a catalyst material for the superhard material, and forms a thermally stable region extending a depth of at least around 300 microns from the working surface of the body of superhard material.

### FIELD

This disclosure relates to polycrystalline super hard constructions and methods of making such constructions, particularly but not exclusively to constructions comprising polycrystalline diamond (PCD) structures attached to a substrate, and tools comprising the same, particularly but not exclusively for use in rock degradation or drilling, or for boring into the earth in the oil and gas industry.

### BACKGROUND

Polycrystalline diamond (PCD) is an example of a super hard material (also called a superabrasive material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is often formed on a cobalt-cemented tungsten carbide substrate, which provides a source of cobalt solvent-catalyst for the PCD. Materials that do not promote substantial coherent intergrowth between the diamond grains may themselves form strong bonds with diamond grains, but are not suitable solvent-catalysts for PCD sintering.

Cemented tungsten carbide which may be used to form a suitable substrate is formed from carbide particles being dispersed in a cobalt matrix by mixing tungsten carbide particles/grains and cobalt together then heating to solidify, the cobalt typically comprising 13 wt % or above of the total substrate composition. To form the cutting element with a super hard material layer such as PCD or PCBN, diamond particles or grains or CBN grains are placed adjacent the cemented tungsten carbide body in a refractory metal enclosure such as a niobium enclosure and are subjected to high pressure and high temperature so that inter-grain bonding between the diamond grains or CBN grains occurs, forming a polycrystalline super hard diamond or polycrystalline CBN layer.

In some instances, the substrate may be fully cured prior to attachment to the super hard material layer whereas in other cases, the substrate may be green, that is, not fully cured. In the latter case, the substrate may fully cure during the HTHP sintering process. The substrate may be in powder form and may solidify during the sintering process used to sinter the super hard material layer.

PCD material may be used as an abrasive compact in a wide variety of tools for cutting, machining, milling, grinding, drilling or degrading hard or abrasive materials such as rock, metal, ceramics, composites and wood-containing materials. For example, tool inserts comprising PCD material are widely used within drill bits used for boring into the earth in the oil and gas drilling industry. The working life of super hard tool inserts may be limited by fracture of the super hard material, including by spalling and chipping, or by wear of the tool insert.

In many of these applications, the temperature of the PCD material may become elevated as it engages rock or other workpieces or bodies. Mechanical properties of PCD material such as abrasion resistance, hardness and strength tend to deteriorate at elevated temperatures, which may be promoted by the residual catalyst material within the body of PCD material.

Ever increasing drives for improved productivity in the earth boring field place ever increasing demands on the materials used for cutting rock. Specifically, PCD materials with improved abrasion and impact resistance are required to achieve faster cut rates and longer tool life.

Cutting elements or tool inserts comprising PCD material are widely used in drill bits for boring into the earth in the oil and gas drilling industry where rock drilling and other operations require high abrasion resistance and impact resistance. One of the factors limiting the success of the polycrystalline diamond (PCD) abrasive cutters is the generation of heat due to friction between the PCD and the work material. This heat causes the thermal degradation of the diamond layer. The thermal degradation increases the wear rate of the cutter through increased cracking and spalling of the PCD layer as well as back conversion of the diamond to graphite causing increased abrasive wear.

It is desirable to improve the abrasion resistance of a body of PCD material when used as an abrasive compact in tools such as those mentioned above, as this allows extended use of the cutter, drill or machine in which the abrasive compact is located. This is typically achieved by manipulating variables such as average diamond particle/grain size, overall binder content, particle density and the like. Methods used to improve the abrasion resistance of a PCD composite often result in a decrease in impact resistance of the composite.

For example, it is well known in the art to increase the abrasion resistance of a super hard composite by reducing the overall grain size of the component super hard particles. Typically, however, as these materials are made more wear resistant they become more brittle or prone to fracture.

Abrasive compacts designed for improved wear performance will therefore tend to have poor impact strength or reduced resistance to spalling. This trade-off between the properties of impact resistance and wear resistance makes designing optimised abrasive compact structures, particularly for demanding applications, inherently self-limiting.

Additionally, because finer grained structures will typically contain more solvent/catalyst or metal binder, they tend to exhibit reduced thermal stability when compared to coarser grained structures. This reduction in optimal behaviour for finer grained structures can cause substantial problems in practical applications where the increased wear resistance is nonetheless required for optimal performance.

There is a need to provide super-hard bodies of polycrystalline material such as inserts for cutting or machine tools having effective performance and to provide a more efficient method for making bodies of polycrystalline materials for use as such cutters or inserts. An abrasive compact that can also achieve improved properties of abrasion resistance, fracture and impact resistance and a method of forming such composites are highly desirable.

### SUMMARY

Viewed from a first aspect there is provided a polycrystalline super hard construction comprising:

a body of polycrystalline super hard material, the body of super hard material comprising:

two or more layers comprising a respective mass of super hard grains exhibiting inter-granular bonding and defining a plurality of interstitial regions therebetween; a first layer of said two or more layers differing from a second layer of said two or more layers differing in one or more characteristics;

the body of polycrystalline super hard material having a thickness of greater than around 1.8 mm and having an exposed outer surface forming a working surface, a peripheral surface extending therefrom and an interface surface;

a substrate bonded to at least one of said two or more layers along an interface surface; the substrate comprising a peripheral surface, an interface surface and having a longitudinal axis; wherein one of the interface surface of the substrate or the interface surface of the body of polycrystalline super hard material comprises one or more projections arranged to project from the interface surface, the height of the one or more projections being between around 0.2 mm to around 2.0 mm measured from the lowest point on the interface surface from which the one or more projections extend; and

wherein at least a portion of the body of polycrystalline super hard material is substantially free of a catalyst material for the superhard material, said portion forming a thermally stable region extending a depth of at least around 300 microns from the working surface of the body of polycrystalline super hard material.

Viewed from a second aspect there is provided a method of forming a polycrystalline super hard construction, comprising:

providing a first mass of grains of super hard material;

providing a second mass of grains of super hard material; the first mass of grains differing in one or more characteristics from the second mass of grains;

providing a substrate, the substrate comprising a peripheral surface, an interface surface and having a longitudinal axis;

treating the pre-sinter assembly in the presence of a catalyst/solvent material for the super hard grains at an ultra-high pressure of around 5.5 GPa or greater and a temperature at which the super hard material is more thermodynamically stable than graphite to sinter together the grains of super hard material to form a polycrystalline super hard construction comprising a body of superhard material formed of the first and second mass of grains in adjacent regions, the super hard grains exhibiting inter-granular bonding and defining a plurality of interstitial regions therebetween, a non-super hard phase at least partially filling a plurality of the interstitial regions; the body of polycrystalline super hard material having a thickness of greater than around 1.8 mm and having an exposed outer surface forming a working surface, a peripheral surface extending therefrom and an interface surface;

wherein one of the interface surface of the substrate or the interface surface of the body of polycrystalline super hard material comprises one or more projections arranged to project from the interface surface, the height of the one or more projections being between around 0.2 mm to around 2.0 mm measured from the lowest point on the interface surface from which the one or more projections extend; and

treating at least a portion of the body of polycrystalline super hard material to remove residual catalyst/binder from the interstitial spaces to form a region substantially free of the catalyst/binder material for the superhard material, said portion forming a thermally stable region extending a depth of at least around 300 microns from the working surface of the body of polycrystalline super hard material.

### BRIEF DESCRIPTION OF DRAWINGS

Non-limiting embodiments will now be described by way of example and with reference to the accompanying drawings in which:

FIG. 1 is a schematic drawing of the microstructure of a body of PCD material;

FIG. 2 is a schematic drawing of a PCD compact comprising a PCD structure bonded to a substrate;

FIG. 3 is a schematic cross-section through an embodiment of a cutting element;

FIG. 4a is a perspective view of a substrate of the cutting element of FIG. 3;

FIG. 4b is a schematic plan view of the substrate of the substrate of FIG. 4a;

FIG. 4c is a schematic cross-sectional view of the substrate along the axis A-A shown in FIG. 4b; and

FIG. 5 is a plot of wear scar area against cutting length in a vertical borer test for an embodiment and a conventional PCD cutter.

### DETAILED DESCRIPTION

As used herein, “polycrystalline diamond” (PCD) material comprises a mass of diamond grains, a substantial portion of which are directly inter-bonded with each other and in which the content of diamond is at least about 80 volume percent of the material. In one embodiment of PCD material, interstices between the diamond gains may be at least partly filled with a binder material comprising a catalyst for diamond. As used herein, “interstices” or “interstitial regions” are regions between the diamond grains of PCD material. In embodiments of PCD material, interstices or interstitial regions may be substantially or partially filled with a material other than diamond, or they may be substantially empty. Embodiments of PCD material may comprise at least a region from which catalyst material has been removed from the interstices, leaving interstitial voids between the diamond grains.

As used herein, a “PCD structure” comprises a body of PCD material.

As used herein, a “metallic” material is understood to comprise a metal in unalloyed or alloyed form and which has characteristic properties of a metal, such as high electrical conductivity.

As used herein, “catalyst material” for diamond, which may also be referred to as solvent/catalyst material for diamond, means a material that is capable of promoting the growth of diamond or the direct diamond-to-diamond inter-growth between diamond grains at a pressure and temperature condition at which diamond is thermodynamically stable.

A filler or binder material is understood to mean a material that wholly or partially fills pores, interstices or interstitial regions within a polycrystalline structure.

A multi-modal size distribution of a mass of grains is understood to mean that the grains have a size distribution with more than one peak, each peak corresponding to a respective “mode”. Multimodal polycrystalline bodies may be made by providing more than one source of a plurality of grains, each source comprising grains having a substantially different average size, and blending together the grains or particles from the sources. In one embodiment, the PCD structure may comprise diamond grains having a multimodal distribution.

As used herein, a “super hard material” is a material having a Vickers hardness of at least about 28 GPa. Diamond and cubic boron nitride (cBN) material are examples of super hard materials.

As used herein, a “super hard construction” means a construction comprising a body of polycrystalline super hard material. In such a construction, a substrate may be attached thereto or alternatively the body of polycrystalline material may be free-standing and unbacked.

As used herein, PCBN (polycrystalline cubic boron nitride) material refers to a type of super hard material comprising grains of cubic boron nitride (cBN) dispersed within a matrix comprising metal or ceramic. PCBN is an example of a super hard material.

The term “substrate” as used herein means any substrate over which the super hard material layer is formed. For example, a “substrate” as used herein may be a transition layer formed over another substrate. Additionally, as used herein, the terms “radial” and “circumferential” and like terms are not meant to limit the feature being described to a perfect circle.

As used herein, the term “integrally formed” regions or parts are produced contiguous with each other and are not separated by a different kind of material.

Like reference numbers are used to identify like features in all drawings.

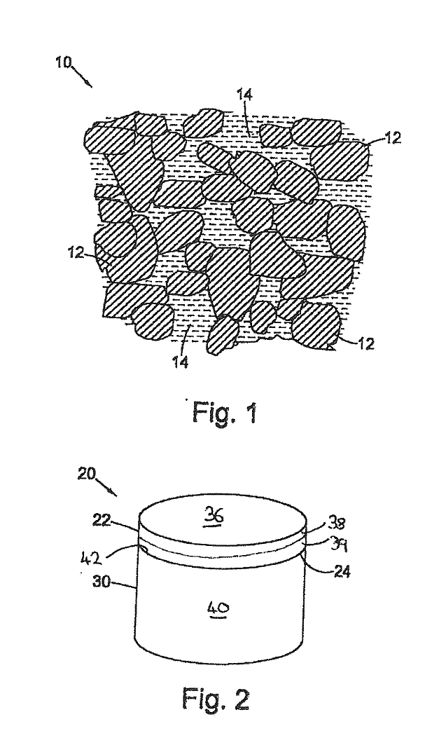

With reference to FIG. 1, a body of PCD material 10 comprises a mass of directly inter-bonded grains of super hard material 12 and interstices 14 between the grains 12, which may be at least partly filled with filler or binder material. FIG. 2 shows an embodiment of a super hard composite compact 20 for use as a cutter comprising a body of super hard material 22 integrally bonded at an interface 24 to a substrate 30. The substrate 30 may be formed of, for example, cemented carbide material and may be, for example, cemented tungsten carbide, cemented tantalum carbide, cemented titanium carbide, cemented molybdenum carbide or mixtures thereof. The binder metal for such carbides may be, for example, nickel, cobalt, chromium, iron or an alloy containing one or more of these metals. Typically, this binder will be present in an amount of 10 to 20 mass %, but this may be as low as 6 mass % or less. Some of the binder metal may infiltrate the body of polycrystalline super hard material 22 during formation of the compact 20.

The compact 20 of FIG. 2 may, in use, be attached to a drill bit (not shown) for oil and gas drilling operations.

The body of super hard material 22 has a free exposed surface 36, which is the surface which, along with its edge, performs the cutting in use.

The body of super hard material 22 comprises two or more layers which differ in respect of one or more characteristics such as CTE, grain size of the respective super hard material grains, and chemical composition. In some embodiments, the body of super hard material 22 comprises a first layer 38 which forms the cutting surface and a second layer 39 which is bonded thereto and which has a surface forming the interface 24 with the substrate 30. The first and second layers 38, 39 differ in one or more characteristics as mentioned above, which may include for example, the first layer 38 being formed of grains of super hard material having a smaller average grain size than the super hard grains of the second layer 39.

In some embodiments, the first layer 38 may comprise super hard grains having an average grain size of around 20 microns or less and the second layer 39 may, for example, comprise super hard grains having an average grain size of greater than around 10 microns or greater than around 20 microns.

In the embodiments described herein, when projections or depressions are described as being formed on the substrate surface, it should be understood that they could be formed instead on the surface of the super hard material layer that interfaces with the substrate interface surface, with the inverse features formed on the substrate 30. Additionally, it should be understood that a negative or reversal of the interface surface 24 is formed on the super hard material layer interfacing with the substrate 30 such that the two interfaces form a matching fit.

As shown in FIGS. 2 to 4c, at one end of the substrate 30 is the interface 24 that interfaces with the super hard material layer 22 which is attached thereto at this interface surface. The substrate 30 is generally cylindrical and has a peripheral surface 40 and a peripheral top surface 42.

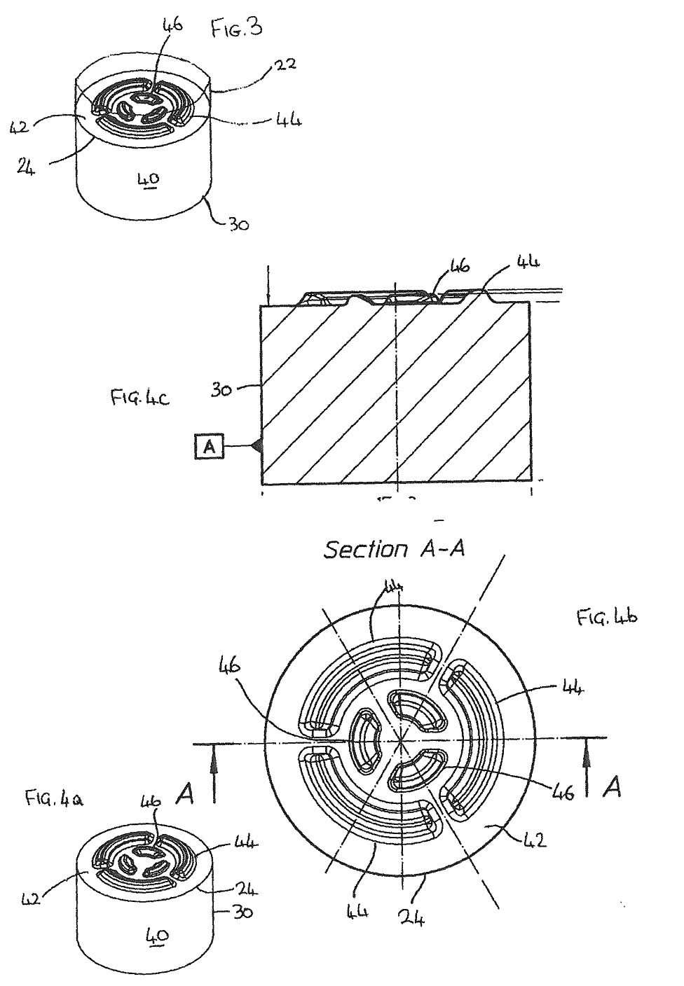

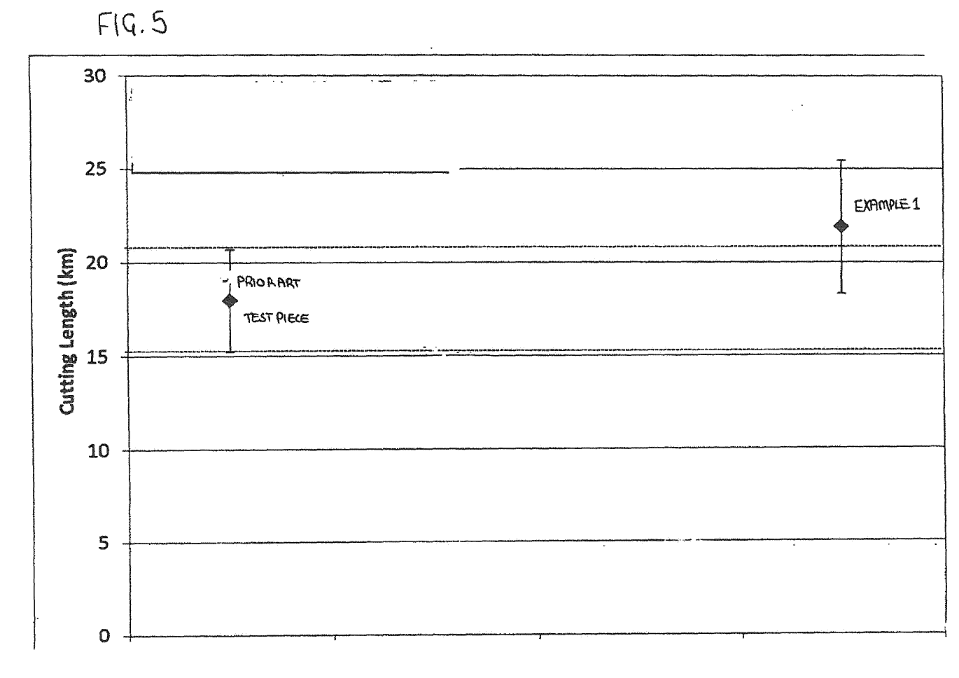

In the example shown in FIGS. 3 and 4a, the interface 24 includes a plurality of spaced-apart projections 44 that are arranged in a substantially annular discontinuous first array and are spaced from the peripheral surface 44 on the peripheral top surface 42 by a distance D, and a second or inner substantially annular discontinuous array of projections 46 that are radially within the first array 44. The distance D ranges, for example from between around 1 mm to around 1.5 mm.

As shown in FIGS. 4a to 4c, in this example the spaced-apart projections 44, 46 are arranged in two arrays which are disposed in two substantially circular paths around a central longitudinal axis of the substrate 30. Also, whilst the projections 46 of the inner array are shown to be closer to the outer array 44 than to the longitudinal central axis of the substrate 30, in other examples the projections 46 of the inner array may be closer to the longitudinal central axis.

The projections 46 in the second array may be positioned to radially align with the spaces between the projections 44 in the first array. The projections 44, 46 and spaces may be staggered, with projections in one array overlapping spaces in the next array. This staggered or mis-aligned distribution of three-dimensional features on the interface surface may assist in distributing compressive and tensile stresses and/or reducing the magnitude of the stress fields and/or arresting crack growth by preventing an uninterrupted path for crack growth.

As shown in FIGS. 4a to 4c, in these examples, the interface surface between the projections 44, 46 is, for example, substantially planar and all or a majority of the projections 44, 46 are shaped such that all or a majority of the surfaces of the projections are not substantially parallel to the cutting face 36 of the super hard material 22 or to the plane through which the longitudinal axis of the substrate extends.

The projections 44, 46 may have a smoothly curving upper surface or may have a sloping upper surface. In some examples, the projections 44, 46 may be slightly trapezoidal or tapered in shape, being widest nearer the interface surface from which they project.

It is believed that such a configuration may act to disturb ‘elastic’ wave formation in the material and deflect cracks at the interface.

In FIGS. 4a to 4c, the projections 44, 46 are spaced substantially equally in/round the respective substantially annular array, with each projection 44, 46 within a given array having the same dimension. However, the projections 44, 46 may be formed in any desired shape, as described above, and spaced apart from each other in a uniform or non-uniform manner to alter the stress fields over the interface surface 24 to form substantially annular concentric discontinuous rings. The projections 44 in the outer array are, as shown in the example of FIGS. 4a to 4c, larger in size than those in the inner array.

In the example shown in FIGS. 3 and 4a to 4c, the outer array includes the same number of projections 44 as the inner array, for example three projections. This permits the compact 20 to have pseudo axi-symmetry thereby providing freedom in positioning the cutter in the tool or drill bit in which it is to be used as it would not require specific orientation, and in this embodiment, there is reflective symmetry along a plane though the central axis. The projections 44, 46 are positioned and shaped in such a way that they inhibit one or more continuous paths along which cracks could propagate across the interface 24.

The arrangement and shape of the projections 44, 46 and spaces therebetween may affect the stress distributions in the compact 20 and may act to improve the cutting element's resistance to crack growth, in particular crack growth along the interface 24, for example by arresting or diverting crack growth across the stress zones in, around and above the projections 44, 46.

As shown in FIG. 3, the depth of super hard material in the region around the central longitudinal axis of the substrate 30 may be substantially the same depth as the depth of the super hard material at the periphery of the body of super hard material 22. This may enable the volume and area of super hard material exposed to the work surface in use not to decrease significantly with wear progression thereby improving the lifespan of the compact 20. It may also assist in stiffening the compact 20 when loaded in the axial direction. Furthermore, it may assist in decreasing or substantially eliminating the possibility of grooving wear formation during use.

In one or more of the above-described examples, the projections 44, 46 of the interfaces 24 may be formed integrally whilst the substrate 30 is being formed through use of an appropriately shaped mold into which the particles of material to form the substrate 30 are placed. Alternatively, the projections 44, 46 of the interface 24 may be created after the substrate 30 has been created or part way through the creation process, for example by a conventional machining process such as EDM or by laser ablation. Similar procedures may be applied to the body of super hard material 22 to create the corresponding shaped interface surface for forming a matching fit with that of the substrate 30, or such a matching fit may be created in the interface of the body of super hard material 22 by placing the particles of super hard material onto a pre-formed substrate 30 and subjecting the combination to the sintering process such that the matching interface in the super hard material layer is formed during sintering.

The body of super hard material 22 may be attached to the substrate 30 by, for example, conventional brazing techniques or by sintering using a conventional high pressure and high temperature technique.

The durability of the compact as a cutter including the substrate 30 and body of super hard material 22 with the aforementioned interface features and/or the mitigation of elastic stress waves therein may be further enhanced if the body of super hard material 22 is leached of catalyst material, either partially or fully, in subsequent processing, or subjected to a further high pressure high temperature sintering process. The leaching may be performed whilst the body of super hard material 22 is attached to the substrate 30 or, for example, by detaching the body of super hard material 22 from the substrate 30, and leaching the detached body of super hard material 22. In the latter case, after leaching has taken place, the body of super hard material 22 may be reattached to the substrate 30 using, for example, brazing techniques or by resintering using a high pressure and high temperature technique.

In some embodiments, the height of the projections 44, 46 is between around 0.2 mm to around 0.8 mm measured from the lowest point of the interface 24 to the maximum height of the projections 44, 46.

As the height of the projections 44, 46 is between around 0.2 mm to around 1 mm, for example around 0.8 mm measured from the lowest point of the interface surface 24 to the maximum height of the projections 44, 46, this enables the body of super hard material 22 to be leached to a depth of greater than around 700 microns or even greater than around 1 mm.

For higher impact applications, it may be advantageous to increase the maximum heights of the projections 44, 46 to, for example, between around 1 mm to around 2 mm, measured from the lowest point of the interface 24 to the highest point of the projections 44, 46.

The total thickness of the body of super hard material 22 may be around 2.2 mm to around 4 mm or greater.

In some embodiments, the substrate 30 comprises around 12 wt % cobalt or less and in some embodiments is between around 9 to around 10 wt % cobalt.

In some embodiments, the body of super hard material 22 may include, for example, one or more of nanodiamond additions in the form of nanodiamond powder up to 20 wt %, salt systems, borides, metal carbides of Ti, V, Nb or any of the metals Pd or Ni.

The grains of super hard material may be for example diamond grains or particles. In the starting mixture prior to sintering they may be, for example, bimodal, that is, the feed comprises a mixture of a coarse fraction of diamond grains and a fine fraction of diamond grains. In some embodiments, the coarse fraction may have, for example, an average particle/grain size ranging from about 10 to 60 microns. By “average particle or grain size” it is meant that the individual particles/grains have a range of sizes with the mean particle/grain size representing the “average”. The average particle/grain size of the fine fraction is less than the size of the coarse fraction, for example between around 1/10 to 6/10 of the size of the coarse fraction, and may, in some embodiments, range for example between about 0.1 to 20 microns.

In some embodiments, the weight ratio of the coarse diamond fraction to the fine diamond fraction ranges from about 50% to about 97% coarse diamond and the weight ratio of the fine diamond fraction may be from about 3% to about 50%. In other embodiments, the weight ratio of the coarse fraction to the fine fraction will range from about 70:30 to about 90:10.

In further embodiments, the weight ratio of the coarse fraction to the fine fraction may range for example from about 60:40 to about 80:20.

In some embodiments, the particle size distributions of the coarse and fine fractions do not overlap and in some embodiments the different size components of the compact are separated by an order of magnitude between the separate size fractions making up the multimodal distribution.

The embodiments consist of at least a wide bi-modal size distribution between the coarse and fine fractions of super hard material, but some embodiments may include three or even four or more size modes which may, for example, be separated in size by an order of magnitude, for example, a blend of particle sizes whose average particle size is 20 microns, 2 microns, 200 nm and 20 nm.

Sizing of diamond particles/grains into fine fraction, coarse fraction, or other sizes in between, may be through known processes such as jet-milling of larger diamond grains and the like.

In embodiments where the super hard material is polycrystalline diamond material, the diamond grains used to form the polycrystalline diamond material may be natural or synthetic.

In some embodiments, the binder catalyst/solvent may comprise cobalt or some other iron group elements, such as iron or nickel, or an alloy thereof. Carbides, nitrides, borides, and oxides of the metals of Groups IV-VI in the periodic table are other examples of non-diamond material that might be added to the sinter mix. In some embodiments, the binder/catalyst/sintering aid may be Co.

The cemented metal carbide substrate may be conventional in composition and, thus, may be include any of the Group IVB, VB, or VIB metals, which are pressed and sintered in the presence of a binder of cobalt, nickel or iron, or alloys thereof. In some embodiments, the metal carbide is tungsten carbide.

An example of a method for producing the PCD compact 20 comprising the body of super hard material 22, as shown in FIGS. 1 to 4c, is now described.

In some embodiments, both the bodies of super hard material 22 and substrate material 30 plus sintering aid/binder/catalyst are applied as powders and are sintered simultaneously in a single UHP/HT process. In the example where the super hard grains comprise diamond and the substrate 30 is formed of carbide material, the diamond grains and mass of carbide to form the substrate 30 are placed in an HP/HT reaction cell assembly and subjected to HP/HT processing. The HP/HT processing conditions selected are sufficient to effect intercrystalline bonding between adjacent grains of abrasive particles and, optionally, the joining of sintered particles to the cemented metal carbide support. In one embodiment, the processing conditions generally involve the imposition for about 3 to 120 minutes of a temperature of at least about 1200 degrees C. and an ultra-high pressure of greater than about 5 GPa.

In some embodiments, the substrate 30 may be pre-sintered in a separate process before being bonded together in the HP/HT press during sintering of the super hard polycrystalline material.

In a further embodiment, both the substrate 30 and a body of polycrystalline super hard material 22 are pre-formed. For example, the bimodal or multimodal feed of super hard grains/particles with optional carbonate binder-catalyst also in powdered form are mixed together, and the mixture is packed into an appropriately shaped canister and is then subjected to extremely high pressure and temperature in a press. Typically, the pressure is at least 5 GPa and the temperature is at least around 1200 degrees C. The preformed body of polycrystalline super hard material is then placed in the appropriate position on the upper surface of the preformed carbide substrate (incorporating a binder catalyst), and the assembly is located in a suitably shaped canister. The assembly is then subjected to high temperature and pressure in a press, the order of temperature and pressure being again, at least around 1200 degrees C. and at least around 5 GPa or more respectively. During this process the solvent/catalyst migrates from the substrate into the body of super hard material and acts as a binder-catalyst to effect intergrowth in the layer and also serves to bond the layer of polycrystalline super hard material to the substrate. The sintering process also serves to bond the body of super hard polycrystalline material to the substrate.

The substrate 30 forms a support body which may comprise cemented carbide in which the cement or binder material comprises a catalyst material for diamond, such as cobalt. In some embodiments, the first and second layers 38, 39 may be formed from diamond-containing sheets and a cup may be provided for use in assembling the diamond-containing sheets onto the substrate 30. The first and second sets of discs may be stacked into the bottom of the cup. In one version of the method, a layer of substantially loose diamond grains may be packed onto the uppermost of the discs. The support body may then be inserted into the cup with the proximate end going in first and pushed against the substantially loose diamond grains, causing them to move slightly and position themselves according to the shape of the non-planar end of the support body to form a pre-sinter assembly.

The pre-sinter assembly may be placed into a capsule for an ultra-high pressure press and subjected to an ultra-high pressure of at least about 5.5 GPa and a high temperature of at least about 1,300 degrees centigrade to sinter the diamond grains and form a PCD element comprising a PCD structure integrally joined to the support body. In one version of the method, when the pre-sinter assembly is treated at the ultra-high pressure and high temperature, the binder material within the support body melts and infiltrates the strata of diamond grains. The presence of the molten catalyst material from the support body is likely to promote the sintering of the diamond grains by intergrowth with each other to form an integral, stratified PCD structure.

In some versions of the method, the aggregate masses may comprise substantially loose diamond grains, or diamond grains held together by a binder material. The aggregate masses of multimodal grains may be in the form of granules, discs, wafers or sheets, and may contain catalyst material for diamond and/or additives for reducing abnormal diamond grain growth, for example, or the aggregated mass may be substantially free of catalyst material or additives. In some embodiments, the aggregate masses may be assembled onto a cemented carbide support body.

In some embodiments, the pre-sinter assembly may be subjected to a pressure of at least about 6 GPa, at least about 6.5 GPa, at least about 7 GPa or even at least about 7.7 GPa or greater.

The one or more indentations in and/or projections 38 from the interface surface 42 of the substrate 30 with the body of PCD material 22 may be formed during the sintering process using a punch with the desired configuration which is punched into the carbide grains prior to sintering, or may, for example, be formed post-sintering using techniques such as electrical discharge machining (EDM) or laser ablation to achieve the desired surface topology to suit the application in which the compact is to be employed.

The step of placing the grains of super hard material into a canister for sintering may, in some embodiments, comprise providing a plurality of sheets comprising the grains and stacking the sheets in the canister to form the aggregation of two layers 38, 39 of super hard grains. In other embodiments, the grains of super hard material may be deposited into the canister using sedimentation or electrophoretic deposition techniques.

After forming the body of sintered polycrystalline material, a finishing treatment may be applied to treat the body of super-hard material 22 to remove sinter catalyst from at least some of the interstices between the inter-bonded grains. In particular, catalyst material may be removed from a region of the PCD structure 22 adjacent the working surface or the side surface or both the working surface and the side surface. This may be done by treating the PCD structure 22 with acid to leach out catalyst material from between the diamond grains, or by other methods such as electrochemical methods. A thermally stable region, which may be substantially porous, may, for example extend a depth of at least about 300 microns or at least about 600 microns or at least about 800 microns or at least about 1000 microns from the working surface 36 of the PCD structure 22. In some examples, the substantially porous region may comprise at most 2 weight percent of catalyst material.

In embodiments where the cemented carbide substrate does not contain sufficient solvent/catalyst for diamond, and where the PCD structure is integrally formed onto the substrate during sintering at an ultra-high pressure, solvent/catalyst material may be included or introduced into the aggregated mass of diamond grains from a source of the material other than the cemented carbide substrate. The solvent/catalyst material may comprise cobalt that infiltrates from the substrate in to the aggregated mass of diamond grains just prior to and during the sintering step at an ultra-high pressure. However, in embodiments where the content of cobalt or other solvent/catalyst material in the substrate is low, particularly when it is less than about 11 weight percent of the cemented carbide material, then an alternative source may need to be provided in order to ensure good sintering of the aggregated mass to form PCD.

Solvent/catalyst for diamond may be introduced into the aggregated mass of diamond grains by various methods, including blending solvent/catalyst material in powder form with the diamond grains, depositing solvent/catalyst material onto surfaces of the diamond grains, or infiltrating solvent/catalyst material into the aggregated mass from a source of the material other than the substrate, either prior to the sintering step or as part of the sintering step. Methods of depositing solvent/catalyst for diamond, such as cobalt, onto surfaces of diamond grains are well known in the art, and include chemical vapour deposition (CVD), physical vapour deposition (PVD), sputter coating, electrochemical methods, electroless coating methods and atomic layer deposition (ALD). It will be appreciated that the advantages and disadvantages of each depend on the nature of the sintering aid material and coating structure to be deposited, and on characteristics of the grain.

In one embodiment, cobalt may be deposited onto surfaces of the diamond grains by first depositing a pre-cursor material and then converting the precursor material to a material that comprises elemental metallic cobalt. For example, in the first step cobalt carbonate may be deposited on the diamond grain surfaces using the following reaction:

Co(NO₃)₂+Na₂CO₃−>CoCO₃+2NaNO₃

The deposition of the carbonate or other precursor for cobalt or other solvent/catalyst for diamond may be achieved by means of a method described in PCT patent publication number WO/2006/032982. The cobalt carbonate may then be converted into cobalt and water, for example, by means of pyrolysis reactions such as the following:

CoCO₃->CoO+CO₂

CoO+H₂->Co+H₂O

In another embodiment, cobalt powder or precursor to cobalt, such as cobalt carbonate, may be blended with the diamond grains. Where a precursor to a solvent/catalyst such as cobalt is used, it may be necessary to heat treat the material in order to effect a reaction to produce the solvent/catalyst material in elemental form before sintering the aggregated mass.

As described above, to assist in improving thermal stability of the sintered structure, the catalysing material may be removed from a region of the polycrystalline layer adjacent an exposed surface thereof. Generally, that surface will be on a side of the polycrystalline layer opposite to the substrate and will provide a working surface for the polycrystalline diamond layer. Removal of the catalysing material may be carried out using methods known in the art such as electrolytic etching, and acid leaching and evaporation techniques.

Polycrystalline bodies formed according to the above-described method may have many applications. For example, they may be used as an insert for a machine tool, in which the cutter structure comprises the body of polycrystalline super hard material according to one or more embodiments.

Embodiments are described in more detail below with reference to the following example which is provided herein by way of illustration only and is not intended to be limiting.

### EXAMPLE

This non-limiting example illustrates a method of forming a compact 20.

A total of around 1.81 g of diamond powder having an average grain size of around 12.6 microns and 1 wt % admixed Cobalt powder having an average diameter of between around 1 to 3 microns is placed in the bottom of a metal cup. A plastic plug is then placed into the cup, and the cup, powder and plug are vibration compacted for a given period of time. The plug is carefully removed, taking care not to disturb the flat surface of the diamond powder. This is to form a first layer 38 in the sintered product.

To form the second layer 39, a total of around 1.16 g of diamond powder having an average grain size of around 25.3 microns and 1 wt % admixed Cobalt powder having a diameter of between around 1 to 3 microns is poured into the cup on top of the first layer of diamond powder and pressed down with another, shorter plastic plug. The plug, diamond powders and cup are then subjected to further vibration compaction. At the end of this compaction cycle, the plug is removed, and a pre-formed tungsten carbide cylinder is inserted into the cup to form the substrate 30. Additional metal cups are pressed over the unit to complete the pre-compact assembly.

The pre-compact assembly is then subjected to an ultra-high pressure of at least about 5.5 GPa and a temperature of at least about 1,250 degrees centigrade to melt the cobalt comprised in the substrate body and sinter the diamond grains to each other to form a composite compact comprising a PCD structure formed joined to the substrate. After sintering, the PCD structure may be further processed, depending on its intended application. For example, it may be further treated by grinding and/or polishing. It may also be subjected to further treatments such as treated in acid to remove residual cobalt within interstitial regions between the inter-grown diamond grains. Removal of a substantial amount of cobalt from the PCD structure is likely to increase substantially the thermal stability of the PCD structure and will likely reduce the risk of degradation of the PCD material.

The body 22 of PCD so formed had a total thickness of the two layers 38, 39 of around 3.0 mm.

To produce the pre-formed body of cemented carbide to form the substrate 30 of the composite compact 20, a green body is formed by mixing, for example, WC grains with Co which is homogenously dispersed in the mixture sufficient to create a sintered product having between around 9 to around 11 wt % Co. A small amount of PEG is included to act as a binder, for example around 1-2 wt %. The green body is sintered at a temperature of around 1400 deg C. for a dwell time of between around 1 to 2 hours, firstly in a hydrogen atmosphere to burn off the PEG, and then in a vacuum for final carbide sintering. The overall sintering time to create the pre-formed substrate 30 may be, for example, around 24 hours.

Prior to sintering, the green body is pressed in a die-set with a punch having the required interface design, in this example that of FIGS. 4a to 4c was used in which the height of the projections 44, 46 ranged from 0.8 mm to 0.3 mm, at room temperature, and up to a pressure of, for example, up to around 200 MPa.

In order to test the wear resistance of the sintered polycrystalline products formed according to the above methods, a first example product (made according to the example described above) was formed and the sintered product was leached for a sufficient leach time (for example around 100 hours) to achieve a leach depth of around 900 microns. For comparison, a conventional leached product having a leach depth from the working surface of around 900 microns was produced which was formed of a single layer of PCD comprising diamond grains comprising around 50 wt % diamond grains having an average grain size of around 4 microns and around 50 wt % diamond grains having an average grain size of around 12 microns.

The diamond layers of the two compacts were then polished and a subjected to a vertical boring mill test. In this test, the wear flat area is measured as a function of the number of passes of the cutter element boring into the workpiece. The results obtained are illustrated graphically in FIG. 5. The results provide an indication of the total wear scar area plotted against cutting length.

It will be seen that the PCD compacts formed according to Example 1 were able to achieve a significantly greater cutting length than the test compact, achieving in this example, a 21% improvement in the average cutting length performance.

In some embodiments, the polycrystalline bodies formed according to the above-described methods may be used as a cutter for boring into the earth, or as a PCD element for a rotary shear bit for boring into the earth, or for a percussion drill bit or for a pick for mining or asphalt degradation. Alternatively, a drill bit or a component of a drill bit for boring into the earth, may comprise the body of polycrystalline super hard material according to any one or more embodiments.

Although particular embodiments have been described and illustrated, it is to be understood that various changes and modifications may be made and equivalents may be substituted for elements thereof and that these examples are not intended to limit the particular embodiments disclosed. For example, the substrate described herein has been identified by way of example. It should be understood that the super hard material may be attached to other carbide substrates besides tungsten carbide substrates, such as substrates made of carbides of W, Ti, Mo, Nb, V, Hf, Ta, and Cr. Furthermore, although the embodiments shown in FIGS. 1 to 2c are depicted in these drawings as comprising PCD structures having sharp edges and corners, embodiments may comprise PCD structures having rounded, bevelled or chamfered edges or corners. Such embodiments may reduce internal stress and consequently extend working life through improving the resistance to cracking, chipping, and fracturing of cutting elements through the interface of the substrate or the super hard material layer having unique geometries.

In addition, the embodiments are not limited to the illustrated interface configuration of FIGS. 3 to 4c, but any arrangement of projections/recesses may be formed on the interface surface 42.

Furthermore, various example arrangements and combinations for cutter structures and inserts are envisaged by the disclosure. The cutter structure may comprise natural or synthetic diamond material. Examples of diamond material include polycrystalline diamond (PCD) material, thermally stable PCD material, crystalline diamond material, diamond material made by means of a chemical vapour deposition (CVD) method or silicon carbide bonded diamond and in one or more other embodiments, the super hard polycrystalline structure described herein may form a PCD element for one or more of a rotary shear bit for boring into the earth, a percussion drill bit, or a pick for mining or asphalt degradation.

1. A polycrystalline super hard construction comprising:
a body of polycrystalline super hard material, the body of super hard material comprising:
two or more layers comprising a respective mass of super hard grains exhibiting inter-granular bonding and defining a plurality of interstitial regions therebetween; a first layer of said two or more layers differing from a second layer of said two or more layers differing in one or more characteristics;
the body of polycrystalline super hard material having a thickness of greater than around 1.8 mm and having an exposed outer surface forming a working surface, a peripheral surface extending therefrom and an interface surface;
a substrate bonded to at least one of said two or more layers along an interface surface; the substrate comprising a peripheral surface, an interface surface and having a longitudinal axis; wherein one of the interface surface of the substrate or the interface surface of the body of polycrystalline super hard material comprises one or more projections arranged to project from the interface surface, the height of the one or more projections being between around 0.2 mm to around 2.0 mm measured from the lowest point on the interface surface from which the one or more projections extend; and
wherein at least a portion of the body of polycrystalline super hard material is substantially free of a catalyst material for the superhard material, said portion forming a thermally stable region extending a depth of at least around 300 microns from the working surface of the body of polycrystalline super hard material.

2. The polycrystalline super hard construction of claim 1, wherein the body of polycrystalline super hard material has a thickness of between around 2.2 to around 4 mm.

3. The polycrystalline super hard construction of claim 2, wherein the body of polycrystalline super hard material has a thickness of between around 3.0 mm to around 4.0 mm.

4. The polycrystalline super hard construction of claim 1, wherein the one or more characteristics comprise one or more of average grain size of the super hard material, coefficient of thermal expansion, super hard material grain size distribution, and super hard material composition.

5. The polycrystalline super hard construction of claim 1, wherein the first layer includes the working surface of the body of polycrystalline super hard material and comprises polycrystalline super hard material having a smaller average grain size than the average grain size of the super hard material of the second layer.

6. (canceled)

7. (canceled)

8. The polycrystalline super hard construction according to claim 1, wherein the thermally stable region extends a depth of at least around between around 300 to around 1000 microns from the working surface of the body of polycrystalline super hard material.

9. (canceled)

10. (canceled)

11. (canceled)

12. The polycrystalline super hard construction according to claim 1, wherein the height of the one or more projections is between around 0.3 mm to around 1.0 mm.

13. The polycrystalline super hard construction of claim 1, wherein the projections are arranged in one or more substantially radial arrays around the central longitudinal axis of the substrate.

14. (canceled)

15. (canceled)

16. (canceled)

17. (canceled)

18. The polycrystalline super hard construction of claim 13, wherein the projections are arranged in a substantially annular discontinuous first array around the central longitudinal axis and spaced from the peripheral surface of the substrate by a distance of between around 1 mm to around 1.5 mm and a second substantially annular discontinuous array of projections radially within the first array;
the projections in the second array being positioned to radially align with spaces between the projections in the first array;
the interface surface between the projections being substantially planar; and
wherein the projections in the first array are of a greater height than the projections in the second array.

19. (canceled)

20. The polycrystalline super hard construction of claim 1, wherein all or a majority of the interface surface between the spaced-apart projections extends in one or more planes which are not substantially parallel to a plane through which the central longitudinal axis of the substrate extends.

21. The polycrystalline super hard construction of claim 1, wherein one or more of the surfaces of all or a majority of the projections extend in one or more planes which are not substantially parallel to the plane of the exposed outer surface of the super hard material layer and/or in one or more planes which are not substantially parallel to a plane through which the central longitudinal axis of the substrate extends.

22. The polycrystalline super hard construction of claim 1, wherein the thickness of the super hard material layer about the central longitudinal axis of the substrate is substantially the same as the thickness of the super hard material layer at the peripheral surface.

23. (canceled)

24. The polycrystalline super hard construction according to claim 1, wherein the substrate comprises a cemented carbide particles bonded together by a binder material, the binder material forming between around 9 to around 11 wt % of the substrate.

25. (canceled)

26. (canceled)

27. The polycrystalline super hard construction according to claim 1, wherein the polycrystalline superhard construction comprises one or more of:
up to 20 wt % nanodiamond additions in the form of nanodiamond powder grains; salts;
borides or metal carbides of at least one of Ti, V, or Nb; or
at least one of the metals Pd or Ni.

28. (canceled)

29. (canceled)

30. (canceled)

31. (canceled)

32. (canceled)

33. (canceled)

34. A method of forming a polycrystalline super hard construction, comprising:
providing a first mass of grains of super hard material;
providing a second mass of grains of super hard material; the first mass of grains differing in one or more characteristics from the second mass of grains;
providing a substrate, the substrate comprising a peripheral surface, an interface surface and having a longitudinal axis;
treating the pre-sinter assembly in the presence of a catalyst/solvent material for the super hard grains at an ultra-high pressure of around 5.5 GPa or greater and a temperature at which the super hard material is more thermodynamically stable than graphite to sinter together the grains of super hard material to form a polycrystalline super hard construction comprising a body of superhard material formed of the first and second mass of grains in adjacent regions, the super hard grains exhibiting inter-granular bonding and defining a plurality of interstitial regions therebetween, a non-super hard phase at least partially filling a plurality of the interstitial regions; the body of polycrystalline super hard material having a thickness of greater than around 1.8 mm and having an exposed outer surface forming a working surface, a peripheral surface extending therefrom and an interface surface;
wherein one of the interface surface of the substrate or the interface surface of the body of polycrystalline super hard material comprises one or more projections arranged to project from the interface surface, the height of the one or more projections being between around 0.2 mm to around 2.0 mm measured from the lowest point on the interface surface from which the one or more projections extend; and
treating at least a portion of the body of polycrystalline super hard material to remove residual catalyst/binder from the interstitial spaces to form a region substantially free of the catalyst/binder material for the superhard material, said portion forming a thermally stable region extending a depth of at least around 300 microns from the working surface of the body of polycrystalline super hard material.

35. The method of claim 34, wherein the body of polycrystalline super hard material has a thickness of between around 2.2 to around 4 mm.

36. (canceled)

37. The method of claim 34, wherein the one or more characteristics comprise one or more of average grain size of the super hard material, coefficient of thermal expansion, super hard material grain size distribution, and super hard material composition.

38. (canceled)

39. (canceled)

40. (canceled)

41. The method of claim 34, wherein the step of treating comprises creating the thermally stable region to extend a depth of between around 300 to around 1000 microns from the working surface of the body of polycrystalline super hard material.

42. (canceled)

43. (canceled)

44. (canceled)

45. (canceled)

46. (canceled)

47. The method of claim 34, wherein the step of providing a substrate comprises providing a substrate comprising cemented carbide particles bonded together by a binder material, the binder material forming between around 9 to around 11 wt % of the substrate.

48. The method of claim 34, wherein the step of subjecting the super hard grains to a pressure comprises subjecting the grains to a pressure of greater than around 6.8 GPa.

49. (canceled)

50. (canceled)
